(19) United States
(12) Patent Application Publication
(10) Pub. No.: US 2024/0152801 A1
(43) Pub. Date: May 9, 2024

(54) METHODS AND APPARATUSES FOR OPERATING LEARNING MODEL

(71) Applicant: NUVI LABS CO., LTD., Incheon (KR)

(72) Inventors: Dae Hoon KIM, Seoul (KR); Jey Yoon RU, Seoul (KR); Seoung Bae PARK, Seoul (KR)

(73) Assignee: NUVI LABS CO., LTD., Incheon (KR)

(21) Appl. No.: 18/090,395

(22) Filed: Dec. 28, 2022

(30) Foreign Application Priority Data
Nov. 9, 2022 (KR) 10-2022-0148836

(51) Int. Cl. G06N 20/00

(52) U.S. Cl. CPC G06N 20/00

(57) ABSTRACT

Provided are a method and an apparatus for operating a learning model. A method for operating a learning model according to one embodiment of the present disclosure comprises selecting at least one training data between previous training data and new training data and learning a previous learning model anew using the at least one selected training data.

### CROSS-REFERENCE TO RELATED APPLICATIONS

This application claims benefit of priority to Korean Patent Application No. 10-2022-0148836 filed on 9 Nov. 2022 in the Korean Intellectual Property Office, the disclosure of which is incorporated herein by reference in its entirety.

### TECHNICAL FIELD

The present disclosure relates to a method and apparatus for operating a learning model.

### BACKGROUND ART

Recently, interest in health has been growing, but on the other hand, people suffering from overweight or obesity are also gradually increasing. Overweight or obesity is a serious problem that causes various diseases, such as diabetes and high blood pressure.

Therefore, to solve overweight or obesity, one's eating habits should be analyzed first. People generally know their likes and dislikes but don't remember what and how often they actually eat. Therefore, to analyze one's own eating habits, it is necessary to identify the food actually consumed and to analyze the individual's eating habits according to the information on the identified foods.

However, since most current technologies use a food image taken through a camera for a simple image search, the search accuracy is considerably low. Moreover, since the accuracy of food type identification in the image search is low, a resulting error increases in the following steps, such as calorie counting.

To solve the problem above, deep learning technology using an artificial intelligence (AI) model is being applied to the field of image recognition. Once learned, the AI model stays in that state during learning. As time progresses, the AI model is fallen behind since it is stuck in the past, and its performance also deteriorates. Once learned, an AI model is only good at classifying images previously learned. In other words, the classification accuracy for a new image not learned before is lower than that obtained from the classification of images completed for pre-learning. Therefore, AI models need continual learning. To this end, an AI model has to be learned by adding new training data for continual learning.

However, it is a common observation that the learning time is proportional to the amount of training data. When training is performed such that training data are continuously added to update the AI model, the time required to train the AI model, the update cycle of the AI model, and the amount of redundant data used for training the AI model will gradually increase.

### SUMMARY

Embodiments of the present disclosure are intended to provide a method and apparatus for operating a learning model, which improves self-diagnosis and recognition performance of the learning model.

However, the technical problem to be solved by the present disclosure is not limited to the above but may be extended to other various problems belonging to the scope not departing from the technical principles and domain of the present disclosure.

According to one embodiment of the present disclosure, a method for operating a learning model executed by an apparatus for operating a learning model may provide a method for operating a learning model comprising selecting at least one training data between previous training data and new training data; and learning a previous learning model anew using the at least one selected training data.

The selecting at least one training data may evaluate the at least one selected training data through the previous learning model and select the training data with the highest ratio of a predetermined evaluation index among the at least one selected training data.

The method may further including comparing the newly learned learning model with the previous learning model in terms of at least one of performance, accuracy, and speed; and learning the previous learning model anew using the rest of the selected training data if the newly learned learning model is inferior to the previous learning model in terms of at least one of performance, accuracy, and speed and updating the previous learning model to the newly learned learning model if the newly learned learning model is better than the previous learning model in terms of at least two or more of performance, accuracy, and speed.

The selecting at least one training data may select at least one training data among first training data selected through hard-negative sampling of previous training data, second training data labeled by active-learning of a previous learning model from new training data, and integrated training data integrating the first training data and the second training data.

The selecting at least one training data may select first training data satisfying conditions for hard-negative sampling by sampling training data exceeding a predetermined prediction error value from previous training data.

The selecting at least one training data may calculate a performance index value for determining the performance obtained by applying specific training data in the previous training model using at least one performance index among F1-score, accuracy, mean Average Precision (mAP), and mean Intersection over Union (mIoU).

The selecting at least one training data may calculate an uncertainty score through a score model from the new training data and label new training data for which the calculated uncertainty score exceeds a predetermined threshold value as the second training data.

The learning a previous learning model anew may perform an operation of continual-learning using one of a memory-mapping method, a selective re-training method, a dynamic expansion method, and a split and duplication method.

The learning a previous learning model anew may train the pre-learned learning model using a memory-mapping method which uploads the first training data and previous training data used for a previous training stage by sampling the training data at a predetermined rate and integrates the labeled second training data into the memory.

Meanwhile, according to another embodiment of the present disclosure, an apparatus for operating a learning model may be provided, the apparatus comprising a database storing a previous learning model and previous training data; a memory storing one or more programs; and a processor executing the stored one or more programs, wherein the processor is configured to select at least one training data between previous training data and new training data and train a previous learning model anew using the at least one selected training data.

The processor may evaluate the at least one selected training data through the previous learning model and select the training data with the highest ratio of a predetermined evaluation index among the at least one selected training data.

The processor may compare the newly learned learning model with the previous learning model in terms of at least one of performance, accuracy, and speed; and learn the previous learning model anew using the rest of the selected training data if the newly learned learning model is inferior to the previous learning model in terms of at least one of performance, accuracy, and speed and update the previous learning model to the newly learned learning model if the newly learned learning model is better than the previous learning model in terms of at least two or more of performance, accuracy, and speed.

The processor may select at least one training data among first training data selected through hard-negative sampling of previous training data, second training data labeled by active-learning of a previous learning model from new training data, and integrated training data integrating the first training data and the second training data.

The processor may select first training data satisfying conditions for hard-negative sampling by sampling training data exceeding a predetermined prediction error value from previous training data.

The processor may calculate a performance index value for determining the performance obtained by applying specific training data in the previous training model using at least one performance index among F1-score, accuracy, mean Average Precision (mAP), and mean Intersection over Union (mIoU).

The processor may calculate an uncertainty score through a score model from the new training data and label new training data for which the calculated uncertainty score exceeds a predetermined threshold value as the second training data.

The processor may perform an operation of continual-learning using one of a memory-mapping method, a selective re-training method, a dynamic expansion method, and a split and duplication method.

The processor may learn the previous learning model using a memory-mapping method which uploads the first training data and previous training data used for a previous training stage by sampling the training data at a predetermined rate and integrates the labeled second training data into the memory.

The present disclosure may provide the following effects. However, since it is not meant that a specific embodiment has to provide all of or only the following effects, the technical scope of the present disclosure should not be regarded as being limited by the specific embodiment.

Embodiments of the present disclosure may improve self-diagnosis and recognition performance of a learning model.

Embodiments of the present disclosure use a hard-negative sampling method, an active-learning method, and a continual-learning method, which autonomously determine required training data through a self-diagnosis operation of a learning model and perform continual-learning through sampling and labeling operations, thereby enabling a learning model to perform self-diagnosis and optimally improving the recognition performance of the learning model.

Embodiments of the present disclosure may sample data vulnerable to the current learning model relatively more than invulnerable data during the next training of the learning model and quickly apply the data to the learning.

Embodiments of the present disclosure train a learning model using a memory-mapping method to integrate only necessary training data from conditionally sampled training data, previously learned training data, and newly labeled training data into the memory, thereby performing learning using only a predetermined amount of training data even if the number of training data increases and reducing the learning time, update cycle of the learning model, or redundant data.

### BRIEF DESCRIPTION OF THE DRAWINGS

FIG. 1 illustrates a method for operating a learning model according to one embodiment of the present disclosure.

FIG. 2 illustrates an operation of an apparatus for operating a learning model according to one embodiment of the present disclosure.

FIG. 3 illustrates a method for selecting training data according to one embodiment of the present disclosure.

FIG. 4 illustrates a hard-negative sampling operation in a method for operating a learning model according to another embodiment of the present disclosure.

FIG. 5 illustrates an active-learning operation according to one embodiment of the present disclosure.

FIG. 6 illustrates a memory-mapping method applied to one embodiment of the present disclosure.

FIG. 7 illustrates an augmentation operation in the memory-mapping method applied to one embodiment of the present disclosure.

FIG. 8 illustrates a dynamically expandable network applied to one embodiment of the present disclosure.

FIG. 9 illustrates a structure of an apparatus for operating a learning model according to one embodiment of the present disclosure.

### DESCRIPTION OF EXEMPLARY EMBODIMENTS

Since the present disclosure may be modified in various ways and may provide various embodiments, specific embodiments will be depicted in the appended drawings and described in detail with reference to the drawings. However, it should be understood that the specific embodiments are not intended to limit the gist of the present disclosure; rather, it should be understood that the specific embodiments include all of the modifications, equivalents, or alternatives belonging to the technical principles and scope of the present disclosure. In describing the present disclosure, if it is determined that a detailed description of a related art incorporated herein unnecessarily obscure the gist of the present disclosure, the detailed description thereof will be omitted.

Terms such as “first” and “second” may be used to describe various constituting elements, but the constituting elements should not be limited by the terms. The terms are introduced to distinguish one element from the others.

The technical terms used in the present disclosure have been introduced solely for the purpose of describing a specific embodiment, and it should be noted that the terms are not intended to restrict the technical scope of the present disclosure. Terms used in the present disclosure have been selected as much as possible from general terms relevant to the functions of the present disclosure and currently in wide use; however, the selection of terms may be varied depending on the intention of those persons skilled in the corresponding field, precedents, or emergence of new technologies. Also, in a particular case, some terms may be selected arbitrarily by the applicant, and in this case, detailed definitions of the terms will be provided in the corresponding description of the present disclosure. Therefore, the terms used in the present disclosure should be defined not simply by their apparent name but based on their meaning and context throughout the present disclosure.

It should be understood that the singular expression includes the plural expression unless the context clearly indicates otherwise. In the present disclosure, the terms “comprises” or “have” specify the presence of stated features, numerals, steps, operations, components, parts, or a combination thereof, but do not preclude the presence or addition of one or more other features, numerals, steps, operations, components, parts, or a combination thereof.

In the embodiments of the present disclosure, an object represents an entity that exists in the real world, which may be captured by a camera and recognized. For example, objects may include food in a soup kitchen or restaurant, food in a cafeteria or supermarket, general objects, and means of transportation.

In what follows, embodiments of the present disclosure will be described in detail with reference to appended drawings. Throughout the specification, the same or corresponding constituting element is assigned the same reference number, and repeated descriptions thereof will be omitted.

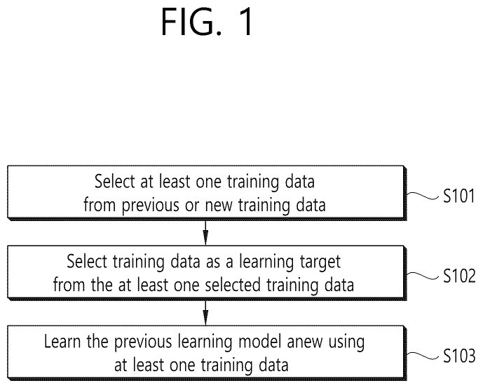

FIG. 1 is a flow diagram illustrating a method for operating a learning model according to one embodiment of the present disclosure.

In the S101 step, an apparatus for operating a learning model according to one embodiment of the present disclosure selects at least one training data from previous or new training data. The apparatus for operating a learning model may select at least one training data among first training data selected through the hard-negative sampling of previous training data, second training data labeled by active-learning of a previous learning model from new training data, and integrated training data integrating the first training data and the second training data. Here, the apparatus for operating a learning model may select the first training data through hard-negative sampling of the previous training data. The apparatus for operating a learning model may select the second training data labeled by active-learning of a previous learning model from the new training data. The apparatus for operating a learning model may select the integrated training model integrating the first and second training data.

In the S102 step, the apparatus for operating a learning model selects at least one training data as a learning target from the at least one selected training data. Here, the apparatus for operating a learning model may evaluate the at least one selected training data through the previous learning model and, based on the evaluation result, select the training data with the highest ratio of a predetermined evaluation index among the at least one selected training data. For example, the predetermined evaluation index may include at least one of uncertainty, outlier, and false negative.

In the S103 step, the apparatus for operating a learning model learns the previous learning model anew using at least one training data. The apparatus for operating a learning model may verify the newly learned learning model and update the previous learning model.

In the process of verifying and updating a previous learning model, the apparatus for operating a learning model learns the previous learning model using at least one training data. The apparatus for operating a learning model compares the performance of a newly learned learning model with that of the previous learning model. Here, the apparatus for operating a learning model executes the training process and performance comparison process for the previous learning model using the remaining two types of selected training data if the performance of the newly learned learning model is inferior to that of the previous learning model. Conversely, the apparatus for operating a learning model may update the previous learning model to the newly learned learning model if the newly learned learning model is better than the previous learning model in terms of at least two or more of performance, accuracy, and speed. If the newly learned learning model is inferior to the previous learning model in terms of at least one of the performance, accuracy, and speed, the apparatus for operating a learning model may use the previous learning model and perform the data collection process in the S101 step, the data selection process in the S102 step, and the verification and model update process in the S103 step again.

In one embodiment of a learning model that learns various types of food, the apparatus for operating a learning model may compare the accuracy of food recognition separately for each food type, group, or category (e.g., cereals, meat, or main side dishes), analyze where the learning model is more robust or weaker, and select a learning model with enhanced accuracy for each food type, group, or category.

Next, the apparatus for operating a learning model continuously checks the new model's performance using newly collected data after the new model is updated. When the new model's performance drops below a certain level, the apparatus for operating a learning model may select training data again and repeat the process of training the learning model.

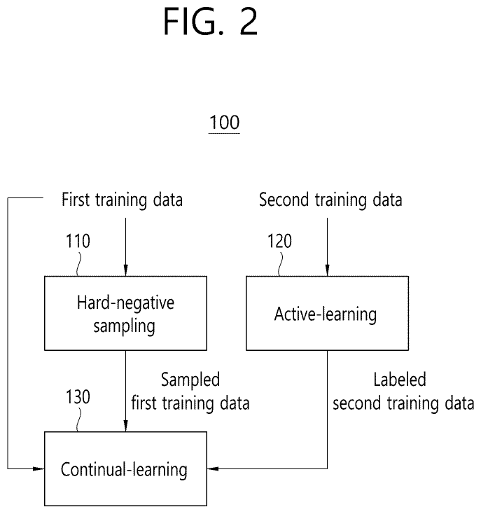

FIG. 2 illustrates an operation of an apparatus for operating a learning model according to one embodiment of the present disclosure.

First, the apparatus 100 for operating a learning model performs the training operation, verification operation, and test operation of the learning model by dividing data into three data sets, such as training data (train_set), validation data (valid_set), and test data (test_set), to measure the performance of the learning model.

Here, the training data (train_set) represents the data required for training the learning model. The validation data (valid_set) represents the data for validating the learning model. The test data (test_set) represents the data for measuring the final performance of the learning model.

As shown in FIG. 2, the apparatus 100 for operating a learning model may perform at least one of a hard-negative sampling operation 110, an active-learning operation 120, and a continual-learning operation 130.

In what follows, the hard-negative sampling operation 110 will be described. The apparatus 100 for operating a learning model receives previous training data used for learning and performs the hard-negative sampling operation 110. The apparatus 100 for operating a learning model samples the first training data by sampling the training data that repeatedly return an erroneous result or yield an uncertainty score higher than a predetermined predicted error value while the learning model is trained. Here, the apparatus 100 for operating a learning model classifies the sampled first training data as the training data difficult to be learned by the learning model. After that, the apparatus 100 for operating a learning model uses the sampled first training data when performing the continual-learning operation.

In what follows, the active-learning operation 120 will be described. The apparatus 100 for operating a learning model performs the active-learning operation 120 by receiving new training data different from the training data used for learning. When new training data is input to the learning model which has been trained so far, the apparatus 100 for operating a learning model samples meaningful second training data based on the learning model and labels only the sampled second training data through the active-learning operation 120. Here, labeling is performed only for the meaningful second training data based on the learning model, which is uncertain second training data among new training data input, that is, the second training data with a high probability that the learning model is unable to predict accurately.

In what follows, the continual-learning operation 130 will be described. The apparatus 100 for operating a learning model receives the first training data from hard-negative sampling, labeled second training data, and training data used for previous learning. The apparatus 100 for operating a learning model uploads the first training data from hard-negative sampling and the training data used for previous learning to the memory by extracting the training data used for previous learning at a predetermined ratio (e.g., 20%) for each version. The apparatus 100 for operating a learning model performs training of the learning model by combining the sampled first training data and the training data extracted at a predetermined ratio, uploaded to the memory, and newly added second training data.

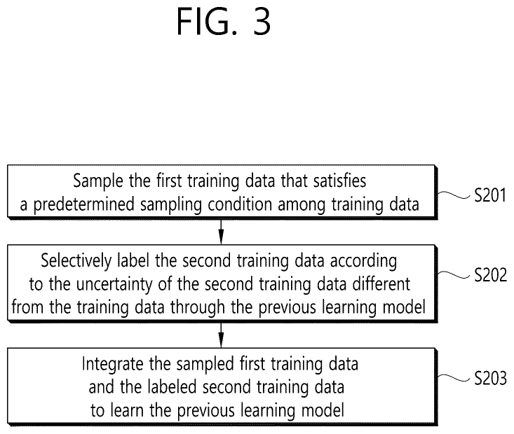

FIG. 3 illustrates a method for selecting training data according to one embodiment of the present disclosure.

As shown in FIG. 3, in the S201 step, the apparatus 100 for operating a learning model samples the first training data that satisfies a predetermined sampling condition among training data.

In the S202 step, the apparatus 100 for operating a learning model selectively labels the second training data according to the uncertainty score of new training data different from the training data through the previous learning model.

In the S203 step, the apparatus 100 for operating a learning model integrates the sampled first training data and the labeled second training data to learn the previous learning model.

On the other hand, to quantitatively measure the learning model's performance, the apparatus 100 for operating a learning model may use at least one performance index among the F1-score, accuracy, mean Average Precision (mAP), and mean Intersection over Union (mIoU).

In what follows, the performance index will be described. The F1-score is the harmonic average of precision and recall, and the more similar the precision and recall are to each other, the higher the F1 score. The F1 score has a value of 0 to 1, and generally, the higher the F1 score, the better the performance.

Accuracy is an index that determines how close predicted data is to actual data. In other words, accuracy may be a value obtained by dividing the number of data cases yielding the same prediction result by the total number of predicted data cases. Accuracy may be an evaluation index that intuitively represents the prediction performance of a learning model.

The mean Average Precision (mAP) may evaluate the performance of object detection and image classification algorithms. When there are multiple object classes, mAP may evaluate the algorithm performance by calculating the average precision (AP) for each class, summing them all, and then dividing the sum by the number of object classes. Here, in the calculation of average precision (AP), the precision inevitably decreases as the recall is increased from 0 to 1 in 0.1 units (a total of 11 values); the AP is obtained by calculating the precision at each unit value and averaging the precision values. In other words, the average of precision values according to 11 recall values is called AP. The AP value may be calculated for each class, and the average value obtained by calculating the AP for the total number of classes is mAP.

Intersection over Union (IoU) is a measurement technique based on the Jaccard index that evaluates the overlap between two bounding boxes. Here, two bounding boxes consist of a GT box and a detected (predicted) box. By applying IoU, it may be determined whether the detection result is valid. In object detection, how well a bounding box matches the ground truth is measured through the IoU index. The IoU may be used not only for object detection problems but also for image segmentation. In other words, for object detection, IoU is measured through the intersection and union of the GT and predicted values. mIoU is a performance index most frequently used in segmentation and object detection, which is an average value of IoU values. In other words, the IoU is the performance evaluation index for one segmented image, and the mIoU is the performance evaluation index for several images obtained by averaging the IoU values of the respective images.

First of all, the apparatus 100 for operating a learning model may quantitatively measure the learning model's performance using the macro F1 score. Since the macro F1 score calculates the score for each class, it is possible to know in which class the score is low, and in which class the model is robust or degraded. In this regard, methods such as providing additional training data for the classes in which the model is ineffective are commonly employed.

Meanwhile, the apparatus 100 for operating a learning model may determine for which data the learning model is weak or robust through these performance indexes. In addition, through the performance indexes, the apparatus 100 for operating a learning model may sample the training data for which the learning model is currently weak relatively more than the training data for which the learning model is robust and apply the sampled training data to the training of the learning model. Then, the apparatus 100 for operating a learning model may train the learning model relatively more with the training data for which the learning model is weak and make the learning model more robust to the corresponding training data.

In an embodiment of a learning model that learns food, the apparatus 100 for operating a learning model may measure the performance of the learning model by considering accuracy for each food state (e.g., before a meal, after a meal, a large amount of food, one serving of food, leftover food (the amount of food left after serving), food ingredients, and food waste).

When selecting a learning model, the apparatus 100 for operating a learning model may measure the learning model's performance by considering not only the accuracy but also the analysis speed. If two learning models exhibit no significant difference in accuracy, the apparatus 100 for operating a learning model may select the model with a fast analysis speed between the two learning models.

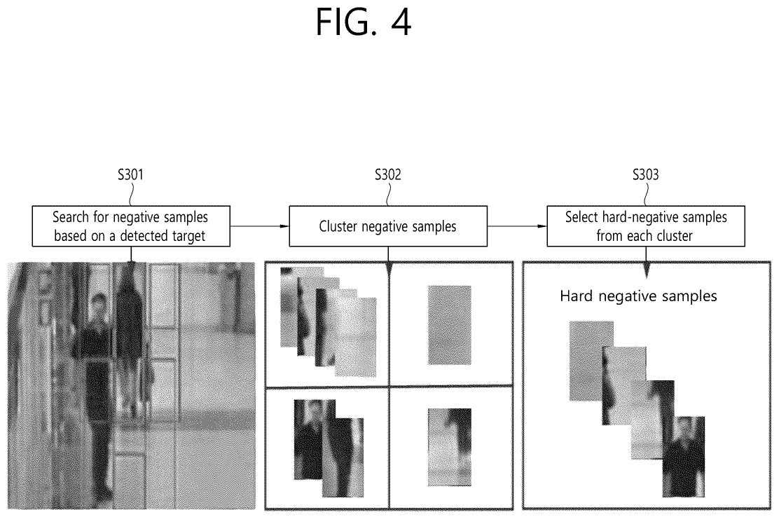

FIG. 4 illustrates a hard-negative sampling operation in a method for operating a learning model according to another embodiment of the present disclosure.

In the S301 step, the apparatus 100 for operating a learning model search for negative samples based on a detected target.

In the S302 step, the apparatus 100 for operating a learning model clusters the negative samples.

In the S303 step, the apparatus 100 for operating a learning model selects hard-negative samples from each cluster.

As shown in FIG. 4, the apparatus 100 for operating a learning model selects and stores hard-negative samples obtained as the previous learning model classifies negative samples as positive samples during the learning process. The apparatus 100 for operating a learning model selects a hard-negative sample based on the highest classification score.

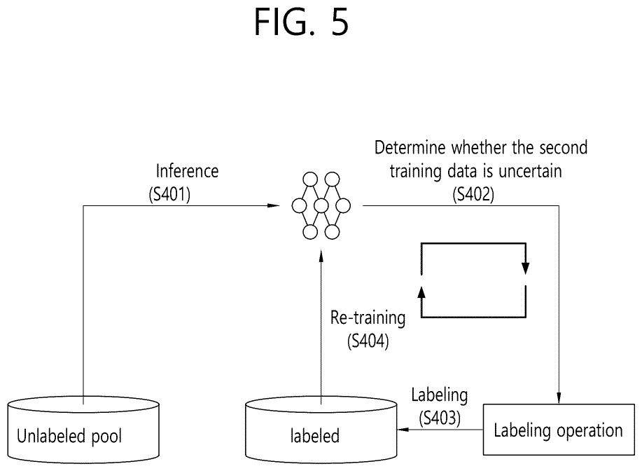

FIG. 5 illustrates an active-learning operation according to one embodiment of the present disclosure.

As shown in FIG. 5, according to the active-learning operation, new training data is first stored in an unlabeled pool.

In the S401 step, the apparatus 100 for operating a learning model performs inference on the new training data stored in the unlabeled pool through a previous learning model.

In the S402 step, the apparatus 100 for operating a learning model may determine whether to label the second training data through the inference result. In other words, the apparatus 100 for operating a learning model may determine if the second training data is uncertain through the inference result. The operation above is also referred to as uncertainty sampling; an uncertain sample, a sample for which it is determined by the learning model to be difficult to predict accurately, may be labeled.

In general, from the inference result, if the uncertainty score exceeds a predetermined threshold value set by the user in terms of a score defined by the score model, the apparatus 100 for operating a learning model determines that uncertainty is high and determines the training data as the second training data to be labeled.

In the S403 step, when it is determined that the second training data is uncertain, the apparatus 100 for operating a learning model performs labeling on the second training data determined to be uncertain. And the labeled second training data is stored in a labeled pool for storing labeled training data.

In the S404 step, the apparatus 100 for operating a learning model re-learns the previous learning model using the labeled second training data stored in the labeled pool. Then, the apparatus for operating a learning model may repeatedly perform determining whether the second training data is uncertain S402, labeling the second training data determined as being uncertain S403, and re-training the learning model using the labeled second training data S404.

As described above, the apparatus 100 for operating a learning model performs inference on the new data through the learned learning model and samples data with high uncertainty during the inference. At this time, the criterion is based on the score predicted by the model. Here, the apparatus 100 for operating a learning model may determine whether an object is detected and perform an active-learning operation on a learning model performing object detection or an object classification model. The apparatus for operating a learning model may sample uncertain data, perform labeling by a user, and then re-train the learning model or the object classification model using the labeled data.

Meanwhile, in the continual-learning operation related to the S203 step of FIG. 3, the apparatus 100 for operating a learning model performs continual-learning and training with new data so that the learning model doesn't fall behind. However, when learning is performed only with new training data without employing the training data used for previous learning, the learning model forgets the previously learned training data. However, if a new learning model is trained by merging all the training data, a problem occurs that the learning time is elongated. Therefore, the apparatus for operating a learning model performs continual-learning on the learning model.

The apparatus for operating a learning model may perform the continual-learning operation by using one of the memory-mapping method, selective re-training method, dynamic expansion method, and split and duplication method.

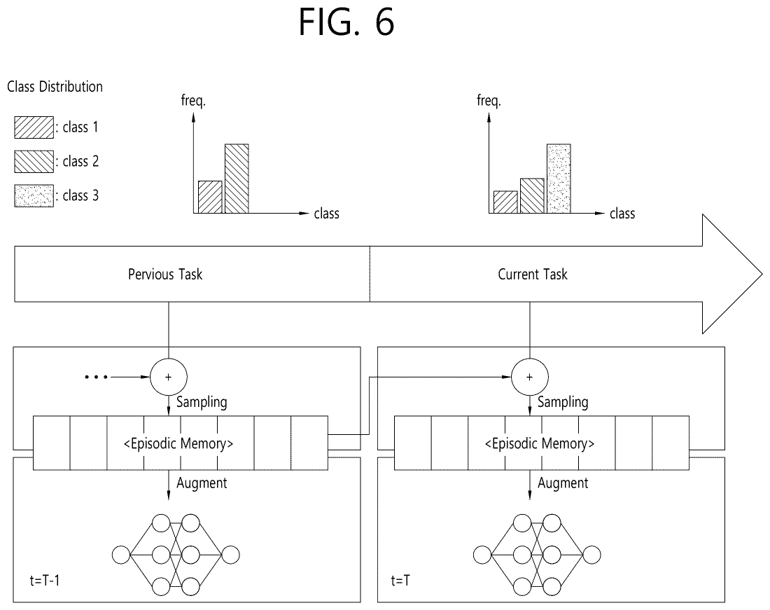

FIG. 6 illustrates a memory-mapping method applied to one embodiment of the present disclosure.

When new data is added to the learning model, it is necessary to determine whether to learn all the data from the beginning or only the added data. The former is problematic in that training takes a long time, while the latter causes performance degradation for previous data used for training. Accordingly, the apparatus 100 for operating a learning model may perform the continual-learning operation that adds new data while maintaining the performance obtained from previous learning.

As shown in FIG. 6, the apparatus 10 for operating a learning model samples the first training data from a previous task, puts the sampled data in an episodic memory, and performs learning. The apparatus 100 for operating a learning model samples the first training data sampled in the previous task and the second training data for the current task, puts the sampled data in the episodic memory, and performs learning again.

As described above, the apparatus for operating a learning model may use the memory-mapping method among continuous learning methods. The apparatus 100 for operating a learning model may classify previously learned training data into several tasks. For example, training of the learning model may be performed by classifying the training data learned in January, February, and March for the learning model into task 1, task 2, and task 3; sampling only a predetermined ratio (e.g., 20%) of the data from each task; and combining the sampled data with the second training data to be newly learned. In this way, even if the total number of the first and second training data increases, learning may still be performed using only a predetermined number of training data which form a portion of the entire data.

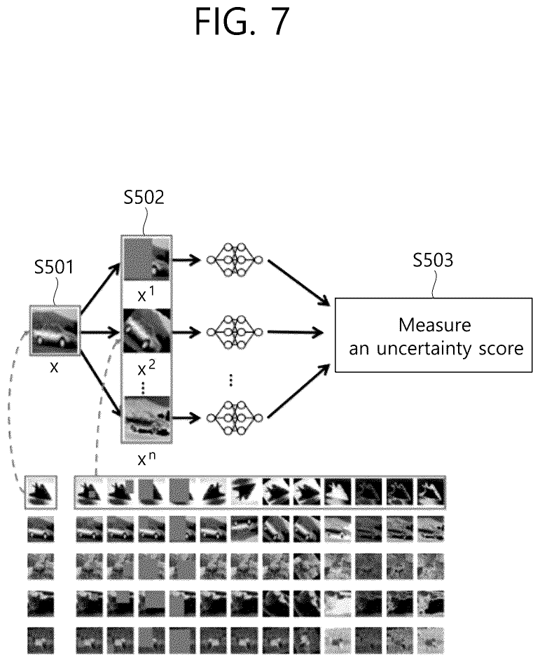

FIG. 7 illustrates an augmentation operation in the memory-mapping method applied to one embodiment of the present disclosure.

As shown in FIG. 7, the apparatus 100 for operating a learning model may perform learning after sampling the first training data from a previous task S501 and performing several augmentation operations on the previously learned object images S502. The apparatus 100 for operating a learning model may measure uncertainty scores, extract object images with low certainty, and perform learning again S503.

In what follows, a selective re-training method will be described. The apparatus 100 for operating a learning model may perform a continual-learning operation using a selective re-training method, which is one of the continual-learning methods. The apparatus 100 for operating a learning model may select and update main weights to be used for re-training through the selective re-training method. At this time, since a catastrophic forgetting phenomenon that causes previous tasks to be forgotten may occur if the main weights are updated a lot, the apparatus 100 for operating a learning model may store the existing weights and perform re-training after restoring the weights. The split and duplication method, which forms the third step of the operation, may use the process above.

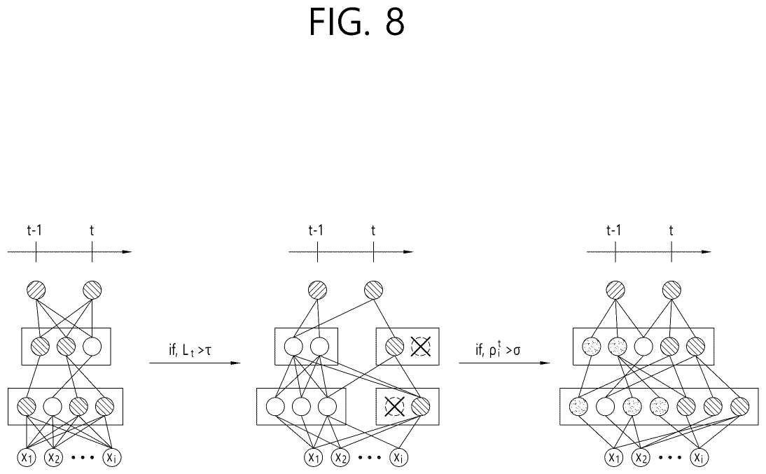

FIG. 8 illustrates a dynamically expandable network applied to one embodiment of the present disclosure.

In what follows, a dynamically expandable network (DEN) method will be described. The apparatus 100 for operating a learning model may perform the continual-learning operation using a dynamically expandable network (DEN) in addition to the memory-mapping method, which is one of the continual-learning methods. In other words, the apparatus 100 for operating a learning model may adapt to a new task while dynamically increasing the number of parameters that may be learned. The dynamically expandable network method may perform the continual-learning operation by adding nodes to the dynamically expandable network since the apparatus 100 for operating a learning model lacks the capacity for the learning model when sufficient performance for a target task is not achieved even if a selective re-training operation has been performed.

Next, the split and duplication method will be described. As described above, to prevent catastrophic forgetting, if the existing weights are changed to be greater than a threshold, the apparatus 100 for operating a learning model copies the existing weights and pastes the copied weights next thereto. If the weights to be updated are not properly selected in the selective re-training method, the number of nodes to be copied and added becomes too large for the split and duplication method, which may cause inefficiency or catastrophic forgetting. Therefore, a process of selecting appropriate weights is required for the selective re-training method.

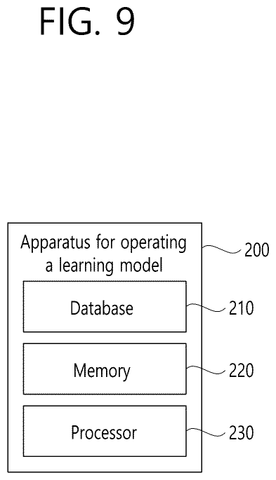

FIG. 9 illustrates a structure of an apparatus for operating a learning model according to one embodiment of the present disclosure.

As shown in FIG. 9, the apparatus 100 for operating a learning model according to one embodiment of the present disclosure includes a database 210, a memory 220, and a processor 230. However, not all of the constituting elements shown in the figure are essential constituting elements. The apparatus 100 for operating a learning model according to one embodiment of the present disclosure may be implemented using a larger or smaller number of constituting elements than shown in the figure.

In what follows, a detailed structure and operation of each constituting element of the apparatus 100 for operating a learning model according to one embodiment of the present disclosure of FIG. 9 will be described.

The database 210 stores a previous learning model, training data, first training data, and second training data related to operating a learning model.

The memory 220 stores one or more programs related to operating a learning model.

The processor 230 executes one or more programs stored in the memory 220. The processor 230 may select at least one training data between previous training data and new training data and train a previous learning model anew using the at least one selected training data.

According to embodiments, the processor 230 may evaluate the at least one selected training data through the previous learning model and select the training data with the highest ratio of a predetermined evaluation index among the at least one selected training data.

According to embodiments, the processor 230 may compare the newly learned learning model with the previous learning model in terms of performance, learn the previous learning model anew using the rest of the selected training data if the newly learned learning model is inferior to the previous learning model in terms of at least one of performance, accuracy, and speed, and update the previous learning model to the newly learned learning model if the newly learned learning model is better than the previous learning model in terms of at least two or more of performance, accuracy, and speed.

According to embodiments, the processor 230 may select at least one training data among first training data selected through hard-negative sampling of previous training data, second training data labeled by active-learning of a previous learning model from new training data, and integrated training data integrating the first training data and the second training data.

According to embodiments, the processor 230 may select first training data satisfying conditions for hard-negative sampling by sampling training data exceeding a predetermined prediction error value from previous training data.

According to embodiments, the processor 230 may calculate a performance index value for determining the performance obtained by applying specific training data in the previous training model using at least one performance index among F1-score, accuracy, mean Average Precision (mAP), and mean Intersection over Union (mIoU).

According to embodiments, the processor 230 may calculate an uncertainty score through a score model from the new training data and label new training data for which the calculated uncertainty score exceeds a predetermined threshold value as the second training data.

According to embodiments, the processor 230 may perform an operation of continual-learning using one of a memory-mapping method, a selective re-training method, a dynamic expansion method, and a split and duplication method.

According to embodiments, the processor 230 may learn the previous learning model using a memory-mapping method which uploads the first training data and previous training data used for a previous training stage by sampling the training data at a predetermined rate and integrates the labeled second training data into the memory.

Meanwhile, when the processor executes a method, a non-transitory computer-readable storage medium may be provided for storing instructions used by the processor to execute the method, the method comprising selecting at least one training data between previous training data and new training data; and learning a previous learning model anew using the at least one selected training data.

Meanwhile, according to one embodiment of the present disclosure, various embodiments described above may be implemented by software including instructions stored in a machine (e.g., a computer) readable storage media. The machine is an apparatus capable of calling stored instructions from the storage medium and operating according to the instructions called, which may include an electronic device (for example, an electronic device (A)) according to the disclosed embodiments. When an instruction is executed by the processor, the processor may perform the function corresponding to the instruction directly or by using other constituting elements under the control of the processor. The instruction may include code generated or executed by a compiler or an interpreter. The machine-readable storage medium may be provided in the form of a non-transitory storage medium. Here, the term ‘non-transitory’ only indicates that the storage medium does not include a signal and is tangible but does not distinguish whether data are stored semi-permanently or temporarily.

Also, according to one embodiment of the present disclosure, the method according to various embodiments described above may be provided by being included in a computer program product. The computer program product may be traded between sellers and buyers as a commodity. The computer program product may be distributed in the form of a machine-readable storage medium (for example, a Compact Disc Read Only Memory (CD-ROM)) or online through an application store (for example, Play Store™). In the case of online distribution, at least part of the computer program product may be at least stored temporarily or generated temporarily in a server of the manufacturer, a server of the application store, or a storage medium such as a memory of a relay server.

Also, according to one embodiment of the present disclosure, various embodiments described above may be implemented in a recording medium that may be read by a computer or a machine similar thereto by using software, hardware, or a combination of both. In some cases, the embodiments of the present disclosure may be implemented within a processor itself. In the case of software implementation, the embodiments such as procedures and functions according to the present disclosure may be implemented by separate software modules. Each of the software modules may perform one or more functions and operations according to the present disclosure.

Meanwhile, the computer instructions for executing processing operations of the machine according to various embodiments described above may be stored in a non-transitory computer-readable medium. When executed by a processor of a specific machine, the computer instructions stored in the non-transitory computer-readable medium instruction the specific machine to perform processing operations for an apparatus according to the various embodiments described above. The non-transitory computer-readable medium refers to a medium that stores data semi-permanently and that may be read by a machine, rather than a medium that stores data for a short time period such as a register, a cache, and a memory. Specific examples of the non-transitory computer-readable medium include a CD, a DVD, a hard disk, a Bluray disk, a USB memory, a memory card, and a ROM.

Also, each of the constituting elements (for example, a module or a program) according to the various embodiments of the present disclosure may be composed of a single or multiple entities; and part of the corresponding sub-elements described above may be omitted, or another sub-element may be further included in the various embodiments. Alternatively or additionally, part of the constituting elements (for example, a module or a program) may be integrated into a single entity, and the functions executed by the respective constituting elements prior to the integration may be performed in the same manner or in a similar manner. The operations executed by a module, a program, or another constituting element according to the various embodiments may be performed in a sequential, parallel, or heuristic manner; or at least part of the operations may be performed in a different order or omitted, or another operation may be added to the operations.

Throughout the document, preferred embodiments of the present disclosure have been described with reference to appended drawings; however, the present disclosure is not limited to the embodiments above. Rather, it should be noted that various modifications of the present disclosure may be made by those skilled in the art to which the present disclosure belongs without leaving the technical scope of the present disclosure defined by the appended claims, and these modifications should not be understood individually from the technical principles or perspectives of the present disclosure.

What is claimed is:

1. A method for operating a learning model executed by an apparatus for operating a learning model, the method comprising:
selecting at least one training data between previous training data and new training data; and
learning a previous learning model anew using the at least one selected training data.

2. The method of claim 1, wherein the selecting at least one training data evaluates the at least one selected training data through the previous learning model and selects the training data with the highest ratio of a predetermined evaluation index among the at least one selected training data.

3. The method of claim 1, further including:
comparing the newly learned learning model with the previous learning model in terms of at least one of performance, accuracy, and speed; and
learning the previous learning model anew using the rest of the selected training data if the newly learned learning model is inferior to the previous learning model in terms of at least one of performance, accuracy, and speed and updating the previous learning model to the newly learned learning model if the newly learned learning model is better than the previous learning model in terms of at least two or more of performance, accuracy, and speed.

4. The method of claim 1, wherein the selecting at least one training data selects at least one training data among first training data selected through hard-negative sampling of previous training data, second training data labeled by active-learning of a previous learning model from new training data, and integrated training data integrating the first training data and the second training data.

5. The method of claim 4, wherein the selecting at least one training data selects first training data satisfying conditions for hard-negative sampling by sampling training data exceeding a predetermined prediction error value from previous training data.

6. The method of claim 4, wherein the selecting at least one training data calculates a performance index value for determining the performance obtained by applying specific training data in the previous training model using at least one performance index among F1-score, accuracy, mean Average Precision (mAP), and mean Intersection over Union (mIoU).

7. The method of claim 4, wherein the selecting at least one training data calculates an uncertainty score through a score model from the new training data and labels new training data for which the calculated uncertainty score exceeds a predetermined threshold value as the second training data.

8. The method of claim 4, wherein the learning a previous learning model anew performs an operation of continual-learning using one of a memory-mapping method, a selective re-training method, a dynamic expansion method, and a split and duplication method.

9. The method of claim 8, wherein the learning a previous learning model anew trains the pre-learned learning model using a memory-mapping method which uploads the first training data and previous training data used for a previous training stage by sampling the training data at a predetermined rate and integrates the labeled second training data into the memory.

10. An apparatus for operating a learning model comprising:
a database storing a previous learning model and previous training data;
a memory storing one or more programs; and
a processor executing the stored one or more programs, wherein the processor is configured to:
select at least one training data between previous training data and new training data and
train a previous learning model anew using the at least one selected training data.

11. The apparatus of claim 10, wherein the processor evaluates the at least one selected training data through the previous learning model and selects the training data with the highest ratio of a predetermined evaluation index among the at least one selected training data.

12. The apparatus of claim 10, wherein the processor compares the newly learned learning model with the previous learning model in terms of at least one of performance, accuracy, and speed; and
learns the previous learning model anew using the rest of the selected training data if the newly learned learning model is inferior to the previous learning model in terms of at least one of performance, accuracy, and speed and updates the previous learning model to the newly learned learning model if the newly learned learning model is better than the previous learning model in terms of at least two or more of performance, accuracy, and speed.

13. The apparatus of claim 10, wherein the processor selects at least one training data among first training data selected through hard-negative sampling of previous training data, second training data labeled by active-learning of a previous learning model from new training data, and integrated training data integrating the first training data and the second training data.

14. The apparatus of claim 13, wherein the processor selects first training data satisfying conditions for hard-negative sampling by sampling training data exceeding a predetermined prediction error value from previous training data.

15. The apparatus of claim 13, wherein the processor calculates a performance index value for determining the performance obtained by applying specific training data in the previous training model using at least one performance index among F1-score, accuracy, mean Average Precision (mAP), and mean Intersection over Union (mIoU).

16. The apparatus of claim 13, wherein the processor calculates an uncertainty score through a score model from the new training data and labels new training data for which the calculated uncertainty score exceeds a predetermined threshold value as the second training data.

17. The apparatus of claim 13, wherein the processor performs an operation of continual-learning using one of a memory-mapping method, a selective re-training method, a dynamic expansion method, and a split and duplication method.

18. The apparatus of claim 17, wherein the processor learns the previous learning model using a memory-mapping method which uploads the first training data and previous training data used for a previous training stage by sampling the training data at a predetermined rate and integrates the labeled second training data into the memory.
